(19) United States
(12) Patent Application Publication
(10) Pub. No.: US 2009/0238943 A1
(43) Pub. Date: Sep. 24, 2009

(54) Process for removal of pathogens from liquid eggs

(76) Inventors: Sudarsan Mukhopadhyay, Maple Glen, PA (US); Peggy Tomasula, Titusville, NJ (US); John Luchansky, Souderton, PA (US)

Correspondence Address: USDA, ARS, OTT, 5601 SUNNYSIDE AVE, RM 4-1159, BELTSVILLE, MD, 20705-5131, US

(21) Appl. No.: 12/077,405

(22) Filed: Mar. 19, 2008

(51) Int. Cl. A23L 1/32; A23L 1/015; A23L 1/48

(52) U.S. Cl. 426/614; 426/490; 426/471

(57) ABSTRACT

A method of treating liquid eggs, involving (a)(i) homogenizing liquid eggs to form homogenized liquid eggs and diluting the homogenized liquid eggs with water to form diluted homogenized liquid eggs or (ii) diluting liquid eggs with water to form diluted liquid eggs and homogenizing the diluted liquid eggs to form homogenized diluted liquid eggs and (b) filtering the diluted homogenized liquid eggs or the homogenized diluted liquid eggs through a microfilter to form a permeate wherein the permeate contains less than about 0.25 microbial cells/ml. The liquid eggs are liquid whole eggs, liquid egg yolks, liquid egg whites, or mixtures thereof.

### BACKGROUND OF THE INVENTION

The present invention relates to a method of treating liquid eggs, involving (a)(i) homogenizing liquid eggs to form homogenized liquid eggs and diluting the homogenized liquid eggs with water to form diluted homogenized liquid eggs or (ii) diluting liquid eggs with water to form diluted liquid eggs and homogenizing the diluted liquid eggs to form homogenized diluted liquid eggs and (b) filtering the diluted homogenized liquid eggs or the homogenized diluted liquid eggs through a microfilter to form a permeate wherein the permeate contains less than about 0.25 microbial cells/ml. The liquid eggs may be liquid whole eggs, liquid egg yolks, liquid egg whites, or mixtures thereof.

Eggs and egg products are an important part of the food supply due to their wide use as an ingredient in many food products, and demand for liquid eggs has greatly increased in recent years. There have been a significantly increasing proportion of eggs which are broken in industry for the purpose of processing as liquid egg products (Ahn, D. U., et al., Poultry Science, 76: 914-919 (1997)). The interior of the avian egg is essentially sterile when freshly laid, but improper washing, temperature abuse, and prolonged storage results in microbial invasion of the egg. Although invading organisms are approximately 60% Gram-positive bacteria, the primary spoilage organisms are Gram-negative bacteria. At refrigeration temperatures the primary spoilage microorganisms are psychotrophs from the genera Pseudomonas and Aeromonas (Mackenzie, K. A., and V. B. D. Skerman, Food Technol. Aust., 34: 524-528 (1982)).

Liquid eggs, in addition to their nutritional value, contribute some unique functional properties such as foaming, coagulation, or emulsification to foods. These properties of eggs can be easily impaired by heat treatment, thus liquid egg pasteurization is conducted on a critical temperature-time regime where the egg protein coagulation is kept to a minimal. The U.S. Department of Agriculture (USDA) requires that liquid egg whites (LEW) be heated to at least 56.6° C. and held at that temperature for no less than 3.5 min. However, despite adherence to the pasteurization protocols recommended by USDA, outbreaks of food poisoning from the consumption of egg products or foods manufactured with LEW as ingredients are still occurring. This is due to the fact that current pasteurization technology is not adequate to remove all pathogens effectively from liquid eggs. Although pasteurization eliminates heat sensitive pathogens from eggs, some heat resistant spoilage microorganisms and pathogens, notably spore-forming bacteria, can survive pasteurization and can spoil the food even under refrigerated conditions. Generally only 1 or 2 log cycle reductions of viable bacterial cell counts are achieved by commercial thermal pasteurization, and pasteurized liquid egg products contain more than 10² or 10³ microbial cells/g (Lee, D. U., et al., Biotechnology Progress, 17: 1020-1025 (2001)). The principal bacterial genera found in pasteurized egg products are Alcaligenes, Bacillus, Proteus, Escherichia, Pseudomonas, and Gram positive cocci (Schmidt-Lorenz, W., Collection of Methods for the Microbiological Examination of Foods, Verlag Chemie, Weinheim, pp. 15.1-15.22 (1983); Cunningham, F. E., Egg-product pasteurization, In: Stadelman, W. J., and O. J. Cotterill (Eds.), Egg Science and Technology, pp. 289-322, Food Products Press, New York (1995)). Hence, the shelf life of LEW is very short even under refrigerated conditions. For example, pasteurized liquid eggs chilled to 4.4° C. have a shelf life of only 4 days (Belyavin, C. G., Eggs—the use of fresh eggs, In: Macrae, R., R. K. Robinson, and M. J. Sadler (Eds.), Encyclopedia of Food Science, Food Technology and Nutrition, Academic Press, London, pp. 1519-1523 (1993)). Much effort has been devoted to overcome the limitations of conventional thermal pasteurization and to extend the storage stability of liquid eggs. However, most of the studies concentrated on the microbiological point of view and did not consider the changes in physico-chemical properties of LEW induced by such processes.

Alternative technologies reported for processing of liquid egg products include ultrapasteurization combined with aseptic packaging (Ball Jr., H. R., et al., J. of Food Science, 52: 1212-1218 (1987)), ultrasonic waves (Wrigley, D. M., and N. G. Llorca, J. of Food Protection, 55: 678-680 (1992)), irradiation (Badr, H. M., Food Chemistry, 97(2): 285-293 (2006); Ma, C. Y., et al., Food Research International, 26: 247-254 (1993)), thermoradiation (Schaffner, D. F., et al., J. of Food Science, 54: 902-905 (1989)), pulsed electric fields (Calderón-Miranda, M. L., et al., International J. of Food Microbiology, 51(1): 7-17 (1999); Ma, L., et al., Inactivation of E. coli in liquid whole eggs using pulsed electric fields technology, In: Barbosa-Canovas, G. V., G. Narshimhan, S. Lombardo, and M. R. Okos (Eds.), New Frontiers in Food Engineering, American Institute of Chemical Engineers, New York, pp. 216-221 (1998)), and high hydrostatic pressure (Ponce, E., et al., International J. of Food Microbiology, 43: 15-19 (1998); Lee, D. U., et al., Lebensmittel Wissenschaft and Technologie, 32(5): 299-304 (1999)). However, microbial removal efficiency of these processes are limited and combinations of physical and chemical antimicrobial treatments are often necessary to overcome the limitations of these processes.

There thus remains a need to develop better processes to remove all types and levels of spoilage and pathogenic microorganisms present in unpasteurized eggs such as LEW.

### SUMMARY OF THE INVENTION

In accordance with the present invention there is provided a method of treating liquid eggs, involving (a)(i) homogenizing liquid eggs to form homogenized liquid eggs and diluting the homogenized liquid eggs with water to form diluted homogenized liquid eggs or (ii) diluting liquid eggs with water to form diluted liquid eggs and homogenizing the diluted liquid eggs to form diluted homogenized liquid eggs and (b) filtering the diluted homogenized liquid eggs or the homogenized diluted liquid eggs through a microfilter to form a permeate, wherein the permeate contains less than about 0.25 microbial cells/ml. The liquid eggs may be liquid whole eggs, liquid egg yolks, liquid egg whites, or mixtures thereof.

### BRIEF DESCRIPTION OF THE DRAWINGS

FIG. 1 shows a schematic diagram of pilot system used for liquid egg (e.g., LEW) microfiltration.

FIG. 2 shows influence of two different Cross flow velocities on Permeate flux for 1.4 micron ceramic membrane.

FIG. 3 shows permeate flux vs. TMP at different cross flow velocity.

FIG. 4 shows permeate flux profile of LEW microfiltration under various operating conditions.

FIG. 5 shows foaming properties of LEW before and after Microfiltration (foaming ability).

FIG. 6 shows foaming stability of LEW before and after microfiltration.

FIG. 7 shows viscosity of raw, homogenized and microfiltered (permeate and retentate) LEW. Error bars represents standard deviations.

FIG. 8 shows effectiveness of pilot scale microfiltration for removal of microorganisms from industrial unpasteurized LEW. Error bars represents standard deviations.

FIG. 9 shows estimates of total solids (TS) and total protein (TP) of microfiltered and control samples. Error bars represents standard deviations.

FIG. 10 shows SDS-PAGE and densitometer analysis of control samples and permeates for trial run 10 & 11. Lanes are as follows: 1—Low Mol. Wt Standards; 2—Raw EW; 3—Homogenized EW; 4—Feed EW, pH 9, Run#10; 5—Permeate, pH 9, Run#10; 6—Feed EW (homogenized LEW diluted with water containing salt), pH 6, Run#1; 7—Permeate, pH 6, Run#11.

### DETAILED DESCRIPTION OF THE INVENTION

The present invention relates to a method of treating liquid eggs, involving (a)(i) homogenizing liquid eggs to form homogenized liquid eggs and diluting the homogenized liquid eggs with water to form diluted homogenized liquid eggs or (ii) diluting liquid eggs with water to form diluted liquid eggs and homogenizing the diluted liquid eggs to form diluted homogenized liquid eggs and (b) filtering the diluted homogenized liquid eggs or the homogenized diluted liquid eggs through a microfilter to form a permeate, wherein the permeate contains less than about 0.25 microbial cells/ml. The invention described below utilizes liquid egg whites though the invention can utilize liquid whole eggs, liquid egg yolks, liquid egg whites, or mixtures thereof.

Generally liquid egg whites or liquid egg yolks or liquid eggs are utilized which have not been previously treated (e.g., pasteurized) to remove microorganisms. The viscosity of liquid egg whites is generally about 17-20 cP (e.g., 17-20 cP). The term “liquid egg whites,” as used in this disclosure, means egg whites obtained after separating the whites and the yolks by breaking fresh eggs, and as such, the liquid egg whites are substantially free of egg yolk.

The LEW is homogenized in, for example, a Universal Pilot Plant (Processing Machinery & Supply Co., Philadelphia, Pa.) in two stages (500 psi and 2500 psi). The temperature of LEW entering the homogenizer is generally about 4° C. and the temperature of the homogenized LEW is generally about 6° C. The viscosity of homogenized LEW is generally about 6 to about 8 cP (e.g., 6-8 cP). The LEW may be homogenized using other methods known in the art provided the egg white protein is not adversely affected or denatured. Generally homogenization is an industrial process whereby a fat emulsion, such as liquid egg whites, is subjected to high shear mixing to shear or split the largest fat globules into smaller fat globules and by such means the fat emulsion is stabilized. Homogenization normally takes place by mechanical processing. In one common homogenization process, liquid egg whites are mixed by subjecting the liquid egg whites to high pressure. Liquid egg whites at high in-feed pressure are passed through a narrow gap such that turbulence is created within the liquid egg whites. The turbulence shears the fat globules in the liquid egg whites. In addition, cavitation bubbles are created in the liquid egg whites, which implode and break up fat globules. The result is a product that consists of a stable emulsion. Homogenization procedures may also include rotar-stator mixing. Like high pressure mixing, rotar-stator mixing subjects liquid egg whites to high shear conditions and creates cavitation bubbles in the liquid egg whites such that fat globules are broken up to produce a stable emulsion.

The homogenized LEW is then diluted with deionized water (or potable water) and mixed. Generally the homogenized LEW is diluted with about 1:2 to about 1:4 w/w water (e.g., 1:2 to 1:4 w/w water), preferably about 1:2 w/w water (e.g., 1:2 w/w water); it is desirable to keep dilution at a minimum to minimize downstream processing. The deionized water generally contains food grade salt (e.g., sodium, ammonium or potassium salts such as sodium chloride, ammonium sulfate or potassium chloride) and the salt (e.g., NaCl) concentration is generally about 0.1% to about 1.5% (e.g., 0.1-1.5%), preferably about 0.5% or higher (e.g., 0.5% or higher), more preferably about 0.5% to about 1% (e.g., 0.5-1%); 0.5% NaCl=0.085M. The pH of the diluted homogenized LEW can be unadjusted or adjusted to range from about 6 to about 9 (e.g., 6-9), preferably about 6 to about 7 (e.g., 6-7); agents that adjust the pH include known acidifying agents such as citric acid or hydrochloric acid and/or known buffering agents such as sodium acid pyrophosphate. The viscosity of diluted homogenized LEW (homogenized LEW diluted with water containing salt) is generally about 5 to about 6 cP (e.g., 5-6 cP). In another embodiment, the LEW is diluted with water and mixed and then homogenized using the conditions described above; the viscosity of diluted LEW is generally about 10 to about 12 cP (e.g., 10-12 cP) and the viscosity of homogenized diluted LEW is generally about 6 to about 9 cP (e.g., 6-9 cP).

The feed LEW (LEW which has been first homogenized and then diluted or first diluted and then homogenized) is then filtered through a microfilter to form a permeate, wherein the permeate contains less than about 0.25 microbial cells/ml (e.g., less than 0.25 microbial cells/ml). The microfilter may be a ceramic (alpha alumina) microfilter/membrane such as Membralox® GP membrane (Pall Advanced Separation System, Cortland, N.Y.) although other ceramic membranes with similar material of construction, geometry and pore size distribution may also be used. In the present invention, we conducted microfiltration experiments with ceramic membrane; however, other types of popular membrane materials such as polysulfone, cellulose, polycarbonate, polytetrafluoroethylene and polyvinylidene membranes could be utilized successfully for microfiltration. Generally the average pore size is about 0.5 to about 1.4 microns (e.g., 0.5-1.4 microns), preferably about 0.8 to about 1.4 microns (e.g., 0.8-1.4 microns). The temperature of the feed LEW may be about 15° to about 50° C. (e.g., 15°-50° C.), preferably about 25° to about 40° C. (e.g., 25°-40° C.). Water and salt may be removed from the permeate using standard methods like ultrafiltration. The permeate may be dried to yield powdered egg whites by standard methods such as spray drying.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Liquid Egg Whites: Due to high microbial load and related safety issues from pathogens, sale of unpasteurized LEW is strictly regulated by USDA Food Safety Inspection System (FSIS). For the present work, frozen unpasteurized LEW was obtained from Michael Foods (Klingerstown, Pa.). Chalaza, pieces of broken shells, and other foreign materials were removed from LEW at the breaking plant by wedge wire screening. Upon shipment, the LEW was kept frozen at −20° C. until further use.

Homogenization: Homogenization of LEW was introduced, in part, to bring homogeneity with respect to the protein particle size distribution. The frozen LEW was removed from the freezer and kept in a 4° C. refrigerator for approximately 48 hrs to thaw the material completely. This thawed LEW was homogenized in a Universal Pilot Plant (Processing Machinery & Supply Co., Philadelphia, Pa.) in two stages (500 psi and 2500 psi). Temperature of LEW entering the homogenizer was ˜4° C. and the temperature of homogenized LEW was approximately 6° C.

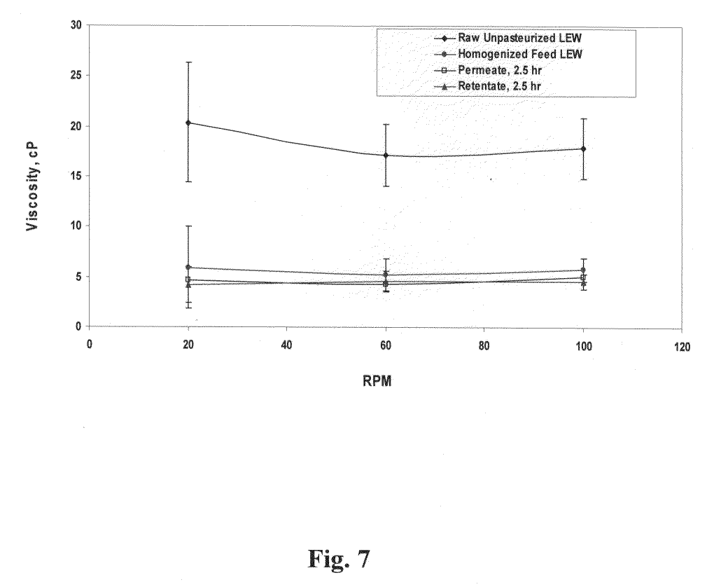

Feed LEW: The homogenization step described above was essential to lower the liquid egg viscosity which improved the fluidity of LEW. Homogenized LEW was then diluted with deionized water (1:2 w/w) containing 0.085 M food grade sodium chloride (CAS No. 7647-14-5, Mallinckrodt, Phillipsburg, N.J.). Surprisingly the water dilution provided additional fluidity suitable for the passage of LEW across the porous membrane, and addition of sodium chloride (0.085M) improved the stability of the soluble protein matrix in the mixture. The viscosity of Homogenized Feed LEW (homogenized LEW diluted with water containing salt) was measured and found to be surprisingly lower than raw unpasteurized unhomogenized material (Raw Unpasteurized LEW in FIG. 7), the fluidity of homogenized LEW thus noticeably improved with dilution with water containing salt. The pH of the LEW was adjusted to 9 and 6 for experimental runs using either 6 N HCl (CAS No. 7647-01-0, Mallinckrodt Chemicals, Phillipsburg, N.J.) or 6 N NaOH (CAS No. 1310-73-2, Fisher Scientific Co., Rochester, N.Y.). This homogenized, diluted, and pH adjusted LEW was kept in a refrigerator at 4° C. prior to use and the clear LEW from the top was used as feed in MF (microfiltration) experiments.

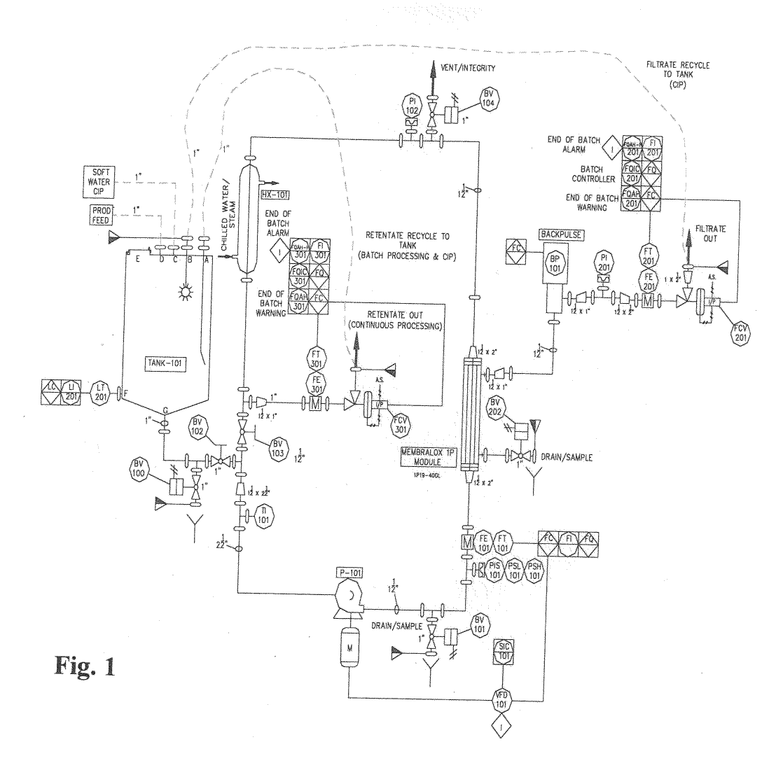

Microfiltration system: Experimental runs were conducted using a Membralox Pilot Skid System (Pall Advanced Separation System, Cortland, N.Y.). A 19 channel ceramic double layer Membralox® GP membrane of 4 mm channel diameter and 1.02 m channel length was used in all runs. The membrane support (12 microns), membrane layer (1.4 microns), and the end sealing all were made of pure alpha alumina. The average pore size of the membrane was 1.4 microns. GP membrane provided optimum soluble macromolecules transfer across the microfiltration membrane. In conventional microfiltration conditions, the natural pressure drop creates asymmetric transmembrane pressure (TMP) from the inlet to the outlet of the flow channel. TMP is the differential pressure between feed side and permeate side and is calculated by subtracting the permeate pressure from the average of feed and retentate pressures. To correct this TMP decrease, GP membranes have a longitudinal permeability gradient built into the support structure without modification of the filtration layer. This design ensures a stable microfiltration regime all along the membrane. Schematic diagram of an example of the MF process is shown in FIG. 1. MF housing is manufactured to sanitary 3A standards (suitable aseptic processing of foods and beverages). The pilot unit contained a feed vessel of 30 gallon capacity, a feed recirculating pump, membrane module containing the ceramic membrane, a heat exchanger unit to heat the feed, a back pulse device to prevent membrane fouling, pressure gauges to detect pressure inside the feed, permeate and retentate lines, flow meters for feed, permeate and retentate, and a number of ball valves at various collection streams.

In tangential crossflow configuration, the feed LEW was pumped tangentially over the ceramic filter membrane and filtered clean LEW flowed out through the shell side or the perimeter of the membrane as what is known as permeate. The microorganisms, solids, and contaminants accumulated at the filtration barrier to form a fouling layer or cake. The residual stream of LEW flowed tangentially to the membrane and is known as the retentate. The cake, constituting an increase in hydraulic resistance, decreased the permeate flux. However, due to tangential flow configuration, a formidable part of the cake dislodged from the membrane and was swept away with the retentate flow. Thus, after an initial rapid increase in cake thickness, cake growth ceased, and the cake thickness became limited to a steady-state value. Correspondingly, after an initial rapid decrease, the permeate flux leveled off and either attained a steady-state or exhibited a slow, long-term decline with time.

Microfiltration experiments: During experimental runs the vessel was charged with approximately 25 gallons (˜80% of capacity) of diluted and pH adjusted feed LEW and was heated up from 4° C. to the experimental temperature by the heat exchanger unit. Experiments were carried out at two different temperatures (25° C. and 40° C.) and at each experimental temperature the MF performance was investigated at two different pHs (pH 6 and pH 9). Temperature above 40° C. was not considered due to the high heat sensitive nature of egg white proteins, although a better fluidity (low viscosity) could be achieved at a high temperature. The feed temperature was accurately controlled within ±1° C. and feed LEW was equilibrated at the experimental temperature for approximately 25 min to stabilize the contents of feed LEW. The pump speed was then adjusted to 65% of the maximum crossflow velocity and the contents of the feed tank were pumped to the module supporting the ceramic microfilter using the recirculation pump. The nominal pore sizes and surface area of the membrane were 1.4μ and 0.24 m² respectively. Each experiment was conducted in duplicate and the maximum duration of these runs were 4-5 hours. TMP and volumetric flow of permeate were recorded at regular intervals (15 min.) as a function of time. During experiments, backpulsing was used only when there was an appreciable decrease in permeate flow. Backpulsing is a method which reversed the filtrate flow back into the module to unclog the foul from the membrane. Generally, backpulsing is a well known cleaning method which momentarily reverses the flow through ceramic membranes and dislodges debris on the membrane surface. Ceramic membranes are ideally suited to this procedure because they are so rigid, and they can take very high pressures. To accomplish back pulsing, a compressor installed in the system pushed permeate liquid back through the ceramic element at high pressure (generally about 250 psi). This pressure ‘spike’ went very quickly through the open pore structure of the element and was intensified as it passed through the narrower openings of the membrane layer on the channels. In a fraction of a second, debris was released from the membrane surface and then joined the normal flow of liquid and particles through the channel.

Clean water flux (CWF) of the membrane was determined each time prior to the start of an experiment with LEG. The feed tank was first filled with deionized (DI) water at the experimental temperature and the pump speed was set to 65%. Then water was recycled through the membrane with the permeate valve closed for 5 min. The water was prefiltered with a 0.2 μm filter. The pump was then stopped and the water was drained from the feed tank. The feed tank was then refilled with deionized water and the pump restarted. The permeate valve was then opened to rinse the shell side of the membrane. The permeate flow rate was measured as a function of time. CWF is the volumetric flow of clean water through area of membrane surface per hour and is typically expressed in liters per square meter per hour. If the measured CWF was significantly lower than the expected value for the pump speed then the standard chemical cleaning procedure (e.g., using caustic soda (NaOH) and bleach (400 ppm of free chlorine)) for the membrane was repeated. The CWF value should be within 10 to 15% of that measured at the first clean water permeability test under the same conditions to confirm cleaning validation.

During each experimental run, both permeate and retentate samples were collected to evaluate the physicochemical properties (i.e., viscosity, total nitrogen, total solids, SDS-PAGE) and microbial properties of the sample. The functional properties were determined by foaming and bleed tests. Microbial quality was assessed thoroughly by direct plating as ‘Total Count (PCA)‘, ‘Total Anaerobic Count (MRS)‘, ‘Yeasts and Molds Count (PDA)‘, ‘Coliforms Count (MacConkey Agar)‘, and ‘Salmonella sp. Count(XLT4)’.

Microbiological analyses: Both permeate and retentate samples (50 ml each) were withdrawn aseptically at regular intervals during the experiments. The total aerobic bacteria, yeasts and molds (YM), lactic acid bacteria (LAB), coliforms, and Salmonella spp. levels were enumerated in liquid egg white (LEW). Total aerobic bacteria and YM were enumerated by serially diluting the LEW sample in 0.1% sterile peptone water as needed and spread plating 100 or 250 μl onto duplicate Plate Count agar (PCA) plates or Potato Dextrose agar (PDA), respectively (Difco, Becton Dickinson, Sparks, Md.), and incubating for up to 72 h at 30° C. For enumeration of total LAB, the LEW sample in 0.1% sterile peptone water was serially diluted as needed and spread plated 100 or 250 μl onto duplicate Mann, Rogosa and Sharp (MRS) agar plates (Difco) and incubated anaerobically (10.1% carbon dioxide, 4.38% hydrogen and balance nitrogen) in a Bactron IV Anaerobic/Environmental Chamber (Sheldon Manufacturing Inc., Cornelius, Oreg.) for 48 h at 37° C. The coliforms levels were determined by serial diluting the LEW sample in 0.1% sterile peptone water as needed and spread plating 100 or 250 μl onto duplicate MacConkey agar (Difco) and incubating for up to 48 h at 37° C. Salmonella spp. were enumerated by serial diluting the LEW sample in 0.1% sterile peptone water as needed and spread plating 100 or 250 μl onto duplicate xylose-lysine-tergitol-4 (XLT4) agar (Difco) and incubating for 48 h at 37° C. Bacterial numbers were expressed as log₁₀ CFU per milliliter.

Foaming Property: The foaming property was expressed by foaming ability (% overrun) and foam stability (g, drained foam). The LEW foam was prepared by beating LEW using a Sunbeam Mixmaster (Model 2350, Boca Raton, Fla.) equipped with double whipping beater. The pH of LEW sample was first adjusted to 7. 150 mL of LEW were placed inside the bowl of the mixer and then beaten for 10 min at the speed setting of 10 which was specified as the ‘egg whipping speed’. The foam produced were gently and carefully filled into three tared weighing boats (100 mL) using small scoops and avoiding entrapped air pockets. Excess foam was scraped off from the top of the boat using a metal spatula to level the top of the foam even with the top of the weighing boat to obtain constant volume for each measurement. The efficiency of foam production was expressed in terms of % overrun (Phillips, L. G., et al., J. of Food Science, 55 (5): 1441-1444 (1990)):

% overrun=((Wt. of 100 mL LEW/Wt. of 100 mL of foam)−1)×100

Foam stability was determined by monitoring the drainage of foam through a small hole (˜0.6 cm) in the bowl. The drained liquid was collected in a tared container on the balance pan and the weight of drained liquid after 1 hr was recorded as the foam stability. Foaming property was measured in triplicate for each experimental sample.

Viscosity: Viscosity was measured in a Brookfield programmable rheometer (Model DV III ultra, Brookfield Engineering Labs, Stoughton, Mass.) using spindle #LV2 and Rheocal software (V3.1-1). For each measurement, about 75 mL of LEW test sample was used and temperature was maintained at 25° C.

SDS-PAGE: SDS-PAGE analysis based on the procedure by Laemmeli (Laemmeli, U. K., Nature, 227: 680-685 (1970)) which was modified for use on the PhastSystem®. Liquid samples (final concentration of 1-2 mg protein ml⁻¹) were dispersed in 0.08 M Tris, 0.0005 M EDTA, 3.5% SDS, pH 6.4, containing 10% mercaptoethanol, and 0.025% bromophenol blue. Low molecular weight markers (94-14.4 kDa; GE Healthcare, Piscataway, N.J.) of known molecular weights were used to help identify protein bands. Electrophoresis was conducting on a PhastStystem® (GE Healthcare, Piscataway, N.J.) using ultra-thin precast 12.5% acrylamide gels with SDS buffer strips. Gels were stained with 0.1% Coomassie Brilliant Blue and destained in water/methanol/acetic acid (6/3/1, v/v/v). Gels were scanned into a densitometer (375A Personal Densitometer SI equipped with Molecular Dynamics, Sunnyvale, Calif.) and protein profiles analyzed using Image Quant software (Version 4.2, Molecular Dynamics).

Total solid (TS): TS was determined according AOAC Official Method 925.31 for egg and egg products (AOAC Official Methods of Analysis, Egg and Egg Products, Chapter 34, pp.1-2 (1995)). 2 gm of LEW sample was weigh in duplicate in an aluminum dish and dried in a Fisher Isotemp oven (Model 230 F) at 100° C. for 1 hour 15 minutes according to the AOAC procedure. Samples were then placed in a desiccator, weighed, and the difference in weight was recorded as moisture content: % TS=100−moisture %.

Total protein (TP): Nitrogen content was determined according to AOAC Official Method 925.31 on duplicate samples using an FP-2000 nitrogen analyzer (LECO Corp., St. Joseph, Mich.) with the combustion chamber set at 1050° C. Total protein (TP) was calculated from total nitrogen content by multiplying by 6.25.

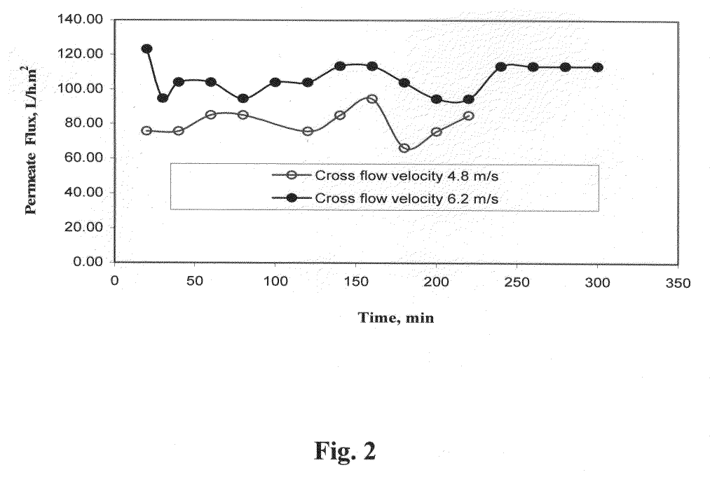

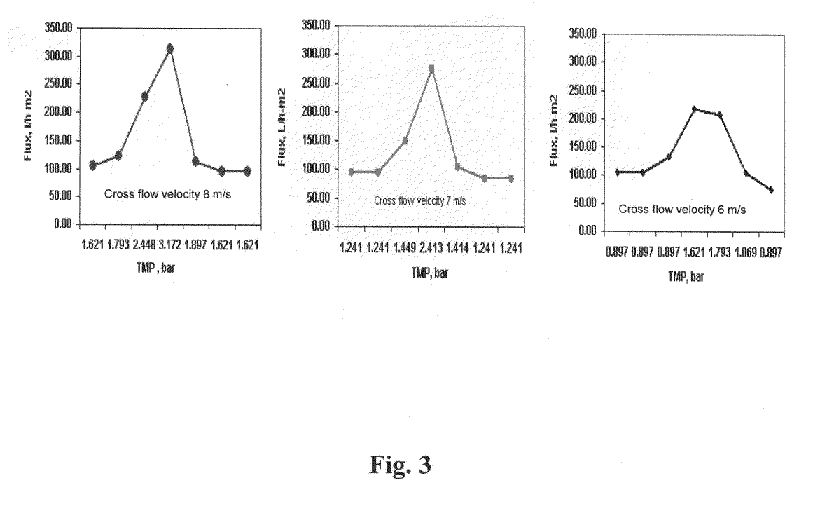

Results and Discussion: Influence of cross flow velocity: A proper cross flow velocity needed to be maintained during MF since it had influence on the formation of fouling layer on the membrane surface and hence the flux. The influence of cross flow velocity on LEW MF is shown in FIG. 2. Fouling during MF of LEW was mainly due to cake formation and concentration polarization, and was controlled by proper choice of operating parameters, such as shear force induced by the cross-flow velocity. Permeate flux was found to surprisingly increase by approximately 20% as cross flow velocity increased from 4.8 m/s to 6.2 m/s, probably by removing the retained particles or reducing the boundary layer thickness during MF of LEW. All MF experiments with LEW were conducted at a cross flow velocity of about 6 m/s which corresponded to 65% of maximum pump speed. Although a higher permeate flux was achievable at a higher cross flow velocity, this option was not pursued since use of very high cross flow velocities led to high energy consumption and to problems with changing TMP along the filter. The change in permeate flux with TMP at different cross flow velocity during MF of LEW is shown in FIG. 3. By increasing the cross flow velocity from 6 m/s to 8 m/s, the permeate flux was increased by approximately 33% (FIG. 3). However, this required 77% increase in energy consumption since energy consumption increased proportionately to the square of cross flow velocity. In this work, a cross flow velocity of about 6 m/s was used which reduced the energy consumption substantially by operating at low TMP while at the same time it provided reasonably good permeate flow. Low TMP operation was possibly a wiser choice considering the possibility of shear damage to delicate egg white proteins and to the ceramic membrane. Additionally, backpulsing, which was an option built into the system to prevent and reverse membrane fouling, was used during the experiment, whenever required, especially at pH 9, to avoid membrane fouling and sustained permeate flow.

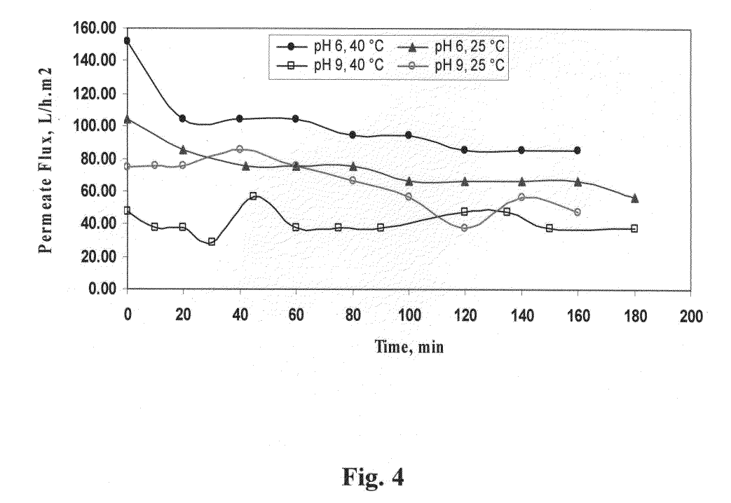

Influence of temperature and pH: Feed temperature, concentration of dissolved or suspended solids, and the physical-chemical properties of feed such as pH had an impact on permeate flow through the membrane. However, even under carefully controlled and optimized conditions, the performance of cross flow microfiltration decreased over time. The profile of permeate flux with time is shown in FIG. 4. Permeate flux was found to remain relatively constant as MF time progressed after a large initial decrease and equilibration period. The decrease in permeate flux with increasing time was probably due to fouling and compaction of boundary layer. At 40° C. the average permeate flux was found to surprisingly increase from 39 l/h.m² to 98 l/h.m² (approximately) as the feed LEW pH decreased from 9 to 6. This amounted to about 148% increase in permeate flux. Similar increasing trend of flux with LEW pH, although much lower (22%), was surprisingly observed at 25° C. The influence of pH on permeate flux was therefore surprisingly quite significant at 40° C. However, the influence of temperature on permeate flux at a constant feed pH was found be inconclusive. At pH 6, the flux was increased by 36% as the temperature increased from 25° C. to 40° C. However, at pH 9 the trend was reversed.

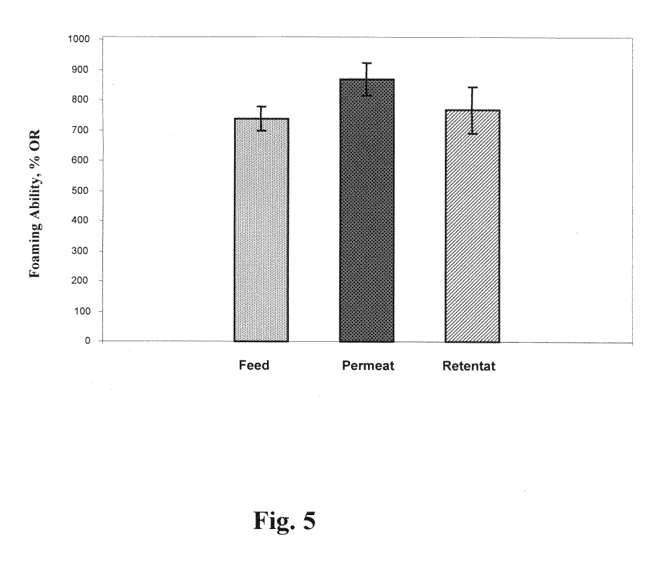

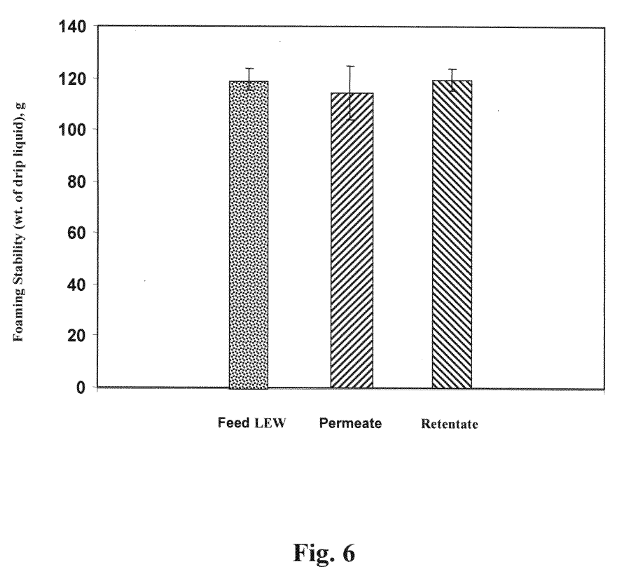

Foaming properties: Egg white has many useful functional properties (e.g., foam formation) and because of these properties egg whites are a desirable ingredient for many food preparations. Foaming is the incorporation of air into a food matrix, usually by whipping. ‘Foaming ability’ or ‘foaming power’ of LEW before and after MF is shown in FIG. 5 and expressed in terms of % OR. The foaming ability of LEW is attributed to the egg white proteins which produce a rigid membrane structure surrounding the entrapped air bubbles. The weight of drip liquid from the foam upon standing is given in FIG. 6 as a measure of ‘foam stability’. These plots provided the information regarding the average foaming property of eight experimental samples from duplicate runs under four different experimental conditions (temperature 25° C. and 40° C; pH 9 and pH 6). Each experimental sample was analyzed in triplicate for the evaluation of foaming ability and foam stability. Error on each bar is the standard error of the mean (SEM) of each sample from the population and was calculated as the standard deviation of the sampling distribution of the mean. Foaming property of LEW was influenced by salt, pH, water, and heat. Combined influence of all of these factors was reflected in the mean bar plots (FIG. 5 and FIG. 6). On average, the permeate LEW was found to have about 18% higher foaming power than the feed counterpart whereas the retentate foaming power was basically the same as the feed. With regard to foaming stability, all three samples (feed, permeate, and retentate), on average, were analyzed to have the same foaming stability. Therefore, MF surprisingly did not affect the foaming properties, namely foaming ability and foam stability of feed LEW.

Viscosity: Raw unpasteurized LEW from the industry was found to be unsuitable for MF for removal of microorganisms due to irreversible blockage of the membrane. In order to improve feasibility of this process, the raw LEW was first homogenized and diluted and this homogenized and diluted LEW was then successfully microfiltered. During MF experiments, samples were withdrawn at various stages of operation and the viscosity was measured. It is evident from FIG. 7 that homogenized LEW surprisingly had almost three fold lower viscosity than industrial raw LEW. The reduced viscosity and associated improved fluidity is one of the important factors that made MF of LEW feasible. Without being bound by theory, in the homogenizer, processing conditions such as pressure and shear stress can lead to a change in physical properties of proteins such as molecular size distribution and texture and hence the fluid viscosity.

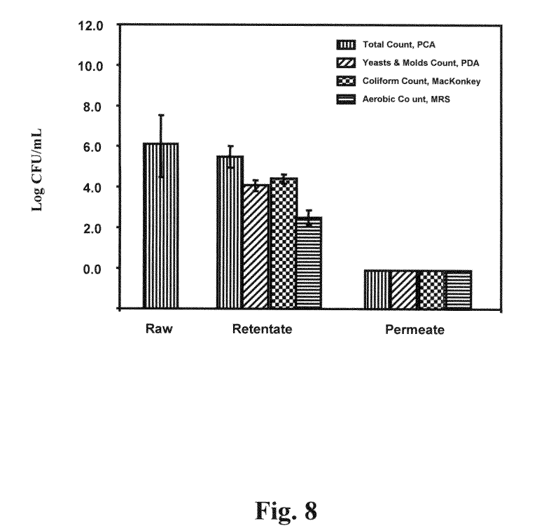

Microbial intervention: The level of contamination in egg shells and hence in liquid eggs in the breaking plant varies widely and the population ranges from a few hundred to tens of millions, and bacteria from 16 genera were found in a survey (Board, R. G., and H. S. Tranter, The microbiology of eggs, In: Stadelman, W. J., and O. J. Cotterill, Editors, Egg science and technology, The Haworth Press, Inc., New York, pp. 81-97 (1995)). The microbiological results of MF intervention are shown in FIG. 8. Due to the presence of different types and levels of microorganisms, LEW samples were analyzed for five major groups: total aerobic bacteria, LAB, yeasts and molds (YM), coliforms, and Salmonella species. FIG. 8 shows overall log reductions of various types and levels of indigenous microorganisms as indicated. We did not detect the presence (≦0.25 CFU/ml) of any Salmonella species in the in-coming raw unpasteurized LEW from plant. Due to wide variation of microbial populations in raw LEW supply, the average result of all eight runs were considered. The experiment design was 2×2, based on two levels of operating pH (6 and 9) and temperature (25° C. and 40° C.). During each of eight experiments (2 pH levels×2 temperatures×2 trials), duplicate samples were withdrawn at multiple times, usually at 0, 5, 10, 30, 60, 150 and 240 minutes into the experiments. We observed the absence (≦0.25 CFU/ml) of any of the target microorganisms in the permeate stream (product) within the first 15 minutes. Out of eight experiments, in two experiments at acidic pH 6 and at 25° C., the total aerobic count and the YM count were 0.33 CFU/mL and 0.29 CFU/mL respectively. Surprisingly, irrespective of experimental conditions, MF successfully removed all incoming microorganisms from the feed LEW (FIG. 8) within 10 min. The product LEW (permeate) from MF was essentially microorganism free (≦0.25 CFU/ml).

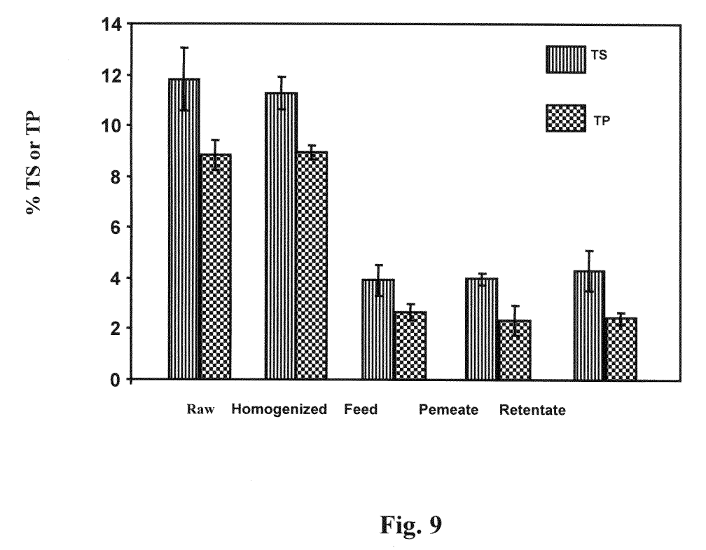

Total solids and total protein: Total solids and total protein content of permeate and retentate samples were analyzed and compared with the feed LEW used for microfiltration. Result of analysis of TS and TP in various LEW samples during the experiments are shown in FIG. 9 which provided the information regarding the average TS and TP of experimental samples from duplicate runs under four different experimental conditions. Each of the experimental samples were analyzed in duplicate for TS and TP. On average the percentage of TP in the feed and permeate were 2.7±0.33 and 2.4±0.5 respectively, whereas that of TS in the feed and permeate were 3.92±0.63 and 3.97±0.22 respectively. It is evident from FIG. 9 that the amount of TS and TP of feed LEW surprisingly did not change appreciably before and after MF.

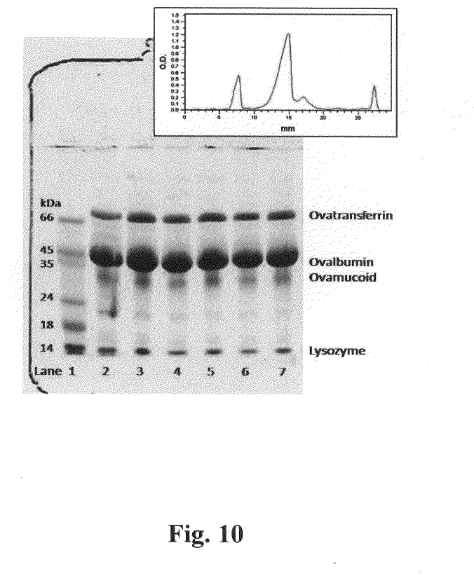

SDS-PAGE analysis: Protein profiles of the different LEW preparations surprisingly were very similar (FIG. 10) with prominent ovalbumin (45 kDa), ovatransferrin (77 kDa), lysoszyme (14 kDa), and minor ovamucoid (28 kDa) bands. Protein distribution in the unhomogenized (lane 2) and homogenized (lane 3) LEW samples were similar and contained 55-60% ovalbumin, 9-13% ovatransferrin, 11% ovamucoid, and 8-10% lysozyme. This is similar to the distribution of egg proteins reported by Desert et al. (Desert, C., et al., J. Agric. Food Chem., 49: 4553-4561 (2001)) except for lysozyme. Egg whites typically contain approximately 3.5% lysozyme. The higher amounts seen in our gels were elevated because it was difficult to separate it from the staining associated with leading edge. Dilution of the LEW prior to filtration shifted the distribution slightly by increasing the ovatransferrin (14-15%) and ovalbumin (62-65%) and reducing the lysozyme (5-7%). We did not detect ovomucin in our gels, probably due to its removal as thick white gel during screening of LEW in plant operation. The protein profiles for the feed LEW and the resulting permeates (lanes 4-7) were essentially the same although two different pH treatments (pH 6 and 9) were performed on these samples. The microfiltration of commercial, homogenized, diluted egg whites surprisingly did not alter the amount of the three major proteins, ovalbumin, ovatransferrin, and ovaglobulin.

Conclusion: Microfiltration for removal of egg borne microorganisms present in unpasteurized LEW from industrial egg breaking plant has been described. The process was capable of removing all levels and groups of microorganisms from the feed LEW. In the process, raw LEW was homogenized and diluted with two times the amount of water for successful membrane separation. The homogenization step was introduced to bring homogeneity to the feed LEW with respect to the protein particle size distribution. The homogenized feed had almost three-fold reduced viscosity. A crossflow velocity of about 6.0 m/s at 65% of pump speed was found to be most suitable. The operating parameters were found to have a large impact on the permeate flux. Influence of pH was greater than the influence of temperature. Foaming properties, namely foaming ability (power) and foam stability, of feed LEW were surprisingly found to be unaltered by the MF process. TP and TS contents of feed also surprisingly remained unchanged during MF. SDS-PAGE and densitometer analysis revealed that the microfiltration of LEW did not alter the distribution of proteins and that the amount of the major proteins surprisingly remained the same after microfiltration. Surprisingly the permeate from the process was essentially microorganism free and yet retained the functional properties of the feed LEW. The product from this process was essentially free of all microorganisms (overall reduction of at least 5 Log₁₀ cfu/mL, with a limit of detection <1 Log₁₀ cfu/mL) but contained a small quantity of salt. However, both the water and salt can be easily removed by adding an ultrafiltration step to the process. Traditionally, the food industry uses ultrafiltration to concentrate proteins in liquid foods such as liquid egg whites and to remove sugar and salt (Froning, G. W., et al., Poultry Science, 66: 1168-1173 (1987)). Alternatively, the microorganism free dilute liquid egg whites from the microfiltration process can be dried to obtain powdered egg whites by a spray drying technique using a food spray dryer. Dried egg whites have a number of advantages over liquid egg whites and are usually preferred in the confectionery industry.

All of the references cited herein, including U.S. patents, are incorporated by reference in their entirety. Also incorporated by reference in their entirety are the following references: Aranha-Creado, H., et al., Biologicals, 26: 167-172 (1998); Chang, I. S., and C. H. Lee, Desalination, 120: 221-233 (1998); Cheryan, M., Ultrafiltration and Microfiltration Handbook, Technomic Publishing Co., Lancaster, Pa. (1998); Chisti, Y., Critical Reviews in Biotechnology, 21(2): 67-110 (2001); Cunningham, F. E., Egg-product pasteurization, In: Stadelman, W. J., and O. J. Cotterill (Eds.), Egg Science and Technology, pp. 289-322, Food Products Press, New York (1995); Dumay, E., et al., Lebensm.-Wiss. U.-Technol., 29: 606-625 (1996); Ferreira, M., et al., International Journal of Food Science & Technology, 34(1): 27-32 (1999); Garcia-Graells, C., et al., Applied and Environmental Microbiology, 66(10): 4173-4179 (2000); Guerra A., et al., International Dairy Journal, 7(12): 849-861 (1997); Kakalis, L. T., and J. M. Regenstein, Journal of Food Science, 51(6): 1445-1447 (1986); Kuriyel R., and A. L. Zydney, A. L., Sterile filtration and virus filtration, In: Totowa, D. M. (Eds), Methods in biotechnology downstream processing, Humana Press, Vol. 9, pp. 185-194 (2000); Lee, D. U., et al., Innovative Food Science and Emerging Technologies, 4: 387-393 (2003); Lee, D. U., et al., Biotechnology Progress, 17: 1020-1025 (2001); Liu, S., et al., Biotechnol. Prog., 16: 425-434 (2000); Le Bolay, N., and A. Ricard, A., J. Colloid and Interface Science, 170: 154-160 (1995); McGregor, W. C. (Ed.), Membrane separations in biotechnology, Marcel Dekker, New York (1985); Nagaoka, H., et al., Water Sci. Technol., 34:165-172 (1996); Sondi, R., et al., Membrane Technology, 11: 5-8 (2003); Schmidt-Lorenz, W., Collection of Methods for the Microbiological Examination of Foods, Verlag Chemie, Weinheim, pp. 15.1-15.22 (1983); Srinivasan, D., and J. E. Kinsella, Effect of ions on protein conformation and functionality, In: J.P. Cherry (Eds.), Food Protein Deterioration: Mechanisms and Functionality, ACS Symp. Ser. 206, American Chemical Society, Washington, D.C., pp. 327 (1982); Sundaram, S., et al., PDA J Pharm Sci Technol., 53: 186-201 (1999); Tardieu, E., et al., J. Membr. Sci., 156: 131-140 (1999); Ter Steeg, P. F., et al., Applied and Environmental Microbiology, 65(9): 4148-4154 (1999); Tomasula, P. M., N. Datta, J. Call, and J. B. Luchansky, Crossflow microfiltration of skim milk for removal of Bacillus anthracis spores, J. Food Protection, In press; Van Reis, R., and A. Zydney, Curr Opin Biotechnol., 12: 208-211 (2001); Van Der Horst, H. C., and J. H. Hanemaaijer, State of the art, 77: 235-258 (1990); Zeman, L. J., and A. L. Zydney, Microfiltration and ultrafiltration, Principles and applications, Marcel Dekker, New York, N.Y. (1996).

Thus, in view of the above, the present invention concerns (in part) the following:

A method of treating liquid eggs, comprising (or consisting essentially of or consisting of) (a)(i)homogenizing unpasteurized liquid eggs to form homogenized liquid eggs and diluting said homogenized liquid eggs with water to form diluted homogenized liquid eggs or (ii) diluting liquid eggs with water to form diluted liquid eggs and homogenizing said diluted liquid eggs to form homogenized diluted liquid eggs, and (b) filtering said diluted homogenized liquid eggs or said homogenized diluted liquid eggs through a microfilter to form a permeate wherein said permeate contains less than about 0.25 microbial cells/ml (or less than 10 CFU/ml or ≦1 CFU/ml or ≦0.25 CFU/ml), and wherein said liquid eggs are selected from the group consisting of liquid whole eggs, liquid egg yolks, liquid egg whites, and mixtures thereof.

The above method, wherein the viscosity of said homogenized liquid eggs is about 6 to about 8 cP.

The above method, wherein the viscosity of said diluted homogenized liquid eggs is about 5 to about 6 cP.

The above method, wherein the viscosity of said diluted liquid eggs is about 10 to about 12 cP.

The above method, wherein the viscosity of said homogenized diluted liquid eggs is about 9 to about 9 cP.

The above method, wherein said water contains at least one food grade salt. The method wherein said water contains sodium chloride at a concentration of about 0.1% to about 1.5%. The method wherein said water contains sodium chloride at a concentration of about 0.5% or higher. The method wherein said water contains sodium chloride at a concentration of about 0.5% to about 1%.

The above method, wherein said microfilter is a ceramic microfilter. The method wherein said microfilter is an alpha alumina ceramic microfilter.

The above method, wherein said microfilter has an average pore size of about 0.5 to about 1.4 microns. The method wherein said microfilter has an average pore size of about 0.8 to about 1.4 microns.

The above method, further comprising subjecting said permeate to microfiltration.

The above method, further comprising drying said permeate to form powdered eggs.

The above method, wherein said liquid eggs are selected from the group consisting of liquid whole eggs, liquid egg yolks, liquid egg whites, and mixtures thereof. The method wherein said liquid eggs are liquid whole eggs. The method wherein said liquid eggs are liquid egg yolks. The method wherein said liquid eggs are liquid egg whites.

Liquid eggs containing less than about 0.25 microbial cells/ml, said liquid eggs made by the above method. Wherein said liquid eggs are selected from the group consisting of liquid whole eggs, liquid egg yolks, liquid egg whites, and mixtures thereof.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A method of treating liquid eggs, comprising (a)(i)homogenizing unpasteurized liquid eggs to form homogenized liquid eggs and diluting said homogenized liquid eggs with water to form diluted homogenized liquid eggs or (ii) diluting liquid eggs with water to form diluted liquid eggs and homogenizing said diluted liquid eggs to form homogenized diluted liquid eggs, and (b) filtering said diluted homogenized liquid eggs or said homogenized diluted liquid eggs through a microfilter to form a permeate wherein said permeate contains less than about 0.25 microbial cells/ml, and wherein said liquid eggs are selected from the group consisting of liquid whole eggs, liquid egg yolks, liquid egg whites, and mixtures thereof.

2. The method according to claim 1, wherein the viscosity of said homogenized liquid eggs is about 6 to about 8 cP.

3. The method according to claim 1, wherein the viscosity of said diluted homogenized liquid eggs is about 5 to about 6 cP.

4. The method according to claim 1, wherein the viscosity of said diluted liquid eggs is about 10 to about 12 cP.

5. The method according to claim 1, wherein the viscosity of said homogenized diluted liquid eggs is about 9 to about 9 cP.

6. The method according to claim 1, wherein said water contains at least one food grade salt.

7. The method according to claim 1, wherein said water contains sodium chloride at a concentration of about 0.1% to about 1.5%.

8. The method according to claim 7, wherein said water contains sodium chloride at a concentration of about 0.5% or higher.

9. The method according to claim 7, wherein said water contains sodium chloride at a concentration of about 0.5% to about 1%.

10. The method according to claim 1, wherein said microfilter is a ceramic microfilter.

11. The method according to claim 1, wherein said microfilter is an alpha alumina ceramic microfilter.

12. The method according to claim 1, wherein said microfilter has an average pore size of about 0.5 to about 1.4 microns.

13. The method according to claim 1, wherein said microfilter has an average pore size of about 0.8 to about 1.4 microns.

14. The method according to claim 1, further comprising subjecting said permeate to microfiltration.

15. The method according to claim 1, further comprising drying said permeate to form powdered eggs.

16. The method according to claim 1, wherein said liquid eggs are selected from the group consisting of liquid whole eggs, liquid egg yolks, liquid egg whites, and mixtures thereof.

17. The method according to claim 1, wherein said liquid eggs are liquid whole eggs.

18. The method according to claim 1, wherein said liquid eggs are liquid egg yolks.

19. The method according to claim 1, wherein said liquid eggs are liquid egg whites.

20. Liquid eggs containing less than about 0.25 microbial cells/ml, said liquid eggs made by the method according to claim 1.

21. The liquid eggs according to claim 20, wherein said liquid eggs are selected from the group consisting of liquid whole eggs, liquid egg yolks, liquid egg whites, and mixtures thereof.
